(19) United States
(12) Patent Application Publication
(10) Pub. No.: US 2025/0167463 A1
(43) Pub. Date: May 22, 2025

(54) Wiring Set with Plug-In Connector

(71) Applicant: Weidmüller Interface GmbH & Co. KG, Detmold (DE)

(72) Inventors: Stefan APORIUS, Detmold (DE); Marcell NICKOL, Eisenach (DE)

(21) Appl. No.: 18/944,382

(22) Filed: Nov. 12, 2024

(30) Foreign Application Priority Data
Nov. 17, 2023 (DE) 102023132087.4

(51) Int. Cl. H01R 4/20; H01R 4/70; H01R 13/52

(52) U.S. Cl. CPC H01R 4/20; H01R 4/70; H01R 13/521

(57) ABSTRACT

A wiring set with a plug-in connector includes a cable with at least one insulated wire which is connected to a connecting element in an electrically conductive manner. The connecting element is arranged in a continuous receptacle in a contact carrier of the plug-in connector. A first connecting section of the connecting element, with which the at least one insulated wire is fastened onto the connecting element has a first outer diameter which corresponds to an inner diameter of a terminal receptacle of the continuous receptacle of the contact carrier.

This application claims priority of DE 10 2023132 087.4 filed Nov. 17, 2023. The entire content of this application is incorporated herein by reference.

### BACKGROUND OF THE INVENTION

The present invention relates to a wiring set with a plug-in connector.

Wiring sets with plug-in connectors are widely employed as pre-assembled components. In many electrical and electronic devices and industrial production plants, plug-in connectors form the electrical connection component between different modules and devices.

Plug-in connections substantially support simple and fast exchangeability of various devices, production modules and enable the installation of complex and in some cases intermeshed infrastructures. Plug-in connections do not just transmit power and signals, but rather they also form interfaces for data transmission.

The known plug-in connectors have proven their worth, in principle. However, there is a constant need for further development, with greater functionality being created alongside increased safety, compact construction, a smaller number of components and possible variations. The aim of the invention is to solve this problem.

### SUMMARY OF THE INVENTION

A wiring set with a plug-in connector according to the invention includes a cable with at least one insulated wire which is connected to a connecting element in an electrically conductive manner, wherein the connecting element is arranged in a continuous receptacle in a contact carrier of the plug-in connector. A first connecting section of the connecting element, with which the at least one insulated wire is fastened onto the connecting element, has a first outer diameter which corresponds to an inner diameter of a terminal receptacle of the continuous receptacle of the contact carrier.

This solution provides simple sealing, which does not require any accessories which is made possible through the configuration of the first connecting section and the corresponding terminal receptacle.

In a first embodiment, the contact carrier of the plug-in connector is a cylindrical component with a longitudinal axis, with a terminal side of at least one insulated wire and a plug side, wherein the contact carrier has a terminal section, a plug-in section, a circumferential collar, an edge section, a first end face of the terminal side, a second end face of the plug side and at least one continuous receptacle for the connecting element. The contact carrier can advantageously be manufactured in a simple manner from an electrically insulating plastic as an injection-molded part.

A further embodiment includes a seal of an over molding compound formed between the first connecting section of the connecting element and the contact carrier by a narrow clearance or a press fit of the first outer diameter of the first connecting section of the connecting element and the corresponding inner diameter of the terminal receptacle of the continuous receptacle of the contact carrier. This seal is preferably configured as a type of gap seal and does not require any further sealing parts particularly in the case of a static application.

In a further embodiment, a spacing of the outside of the first connecting section to the inside of the terminal receptacle is in a range from a 0.05 mm oversize to a 0.1 mm clearance which makes simple sealing possible.

According to another embodiment, a free end of the first connecting section has an end face configured with a uniform, stable, largely circumferentially accessible mounting edge, wherein the other end of the first connecting section merges into an offset section. The largely circumferential mounting edge does not always have to be closed in its circumference, as this depends on the thickness of the conductor. This provides the possibility of quickly mounting the connecting element in the contact carrier. This can be done manually and/or mechanically using a mounting tool.

In a further embodiment, the offset section of the first connecting section has a second outer diameter which is smaller than the first outer diameter of the first connecting section. Thus, insulated wires with relatively small conductor cross-sections can also advantageously be fastened onto the connecting element.

In an alternate embodiment, the offset section of the first connecting section has a second outer diameter which is the same size as the first outer diameter of the first connecting section. Thus, insulated wires with large conductor cross-sections are able to be employed, with the offset section at the same time also providing a sealing effect.

In a different embodiment, towards the inner region of the continuous receptacle of the contact carrier of the plug-in connector, a seal is formed for the insulation layer of the insulated wires by the offset section of the connecting element.

In a further embodiment, a terminal section of the contact carrier is surrounded by an end section of an insulating body in its end region on the terminal side, wherein the insulating body furthermore surrounds the at least one free insulated wire of the cable and an end region of the cable and firmly connects the plug-in connection to the insulating body. In this manner, simple sealing of the contact carrier on the terminal side is possible.

According to another embodiment, the insulating body is formed from an overmolding compound. This is advantageous, since in this manner different insulating body forms can be formed for handling and strain relief.

In a further embodiment, the over-molding compound is in contact with an exterior of the terminal section in the first quarter of the contact carrier and with the mounting edge of the connecting element and the at least one insulated wire fastened in the first connecting section and thus forms a seal of the connecting element outwards on the terminal side of the plug-in connector. This results in sealing and strain relief of the insulated cable, the connecting element, the continuous receptacle and the terminal section of the contact carrier.

The uniform, stable, largely circumferentially accessible mounting edge is aligned with the edge section of the terminal side of the contact carrier. This provides sealing of the contact carrier, the insulated wire, the connecting element and the continuous receptacle of the contact carrier. The largely circumferential mounting edge does not always have to be closed in its circumference, as this depends on the thickness of the conductor.

The connecting element is a crimping element, wherein the first connecting section is an insulation crimp, a second connecting section is a conductor crimp and a contact section is a plugging socket or a plugging pin. Crimping elements are preferably stamped-and-bent parts as they are inexpensive and commercially available high-quality components.

In an alternative embodiment, the connecting element can be a turned part which is advantageous for special designs, for example, and increases the range of applications.

The subject invention provides the following advantages:
a stable largely circumferentially accessible mounting edge of the connecting element;
sealing against over-molding compound at the first connecting section;
sealing inwardly through an offset at the insulation of the insulated wires, depending on the insulation diameter by contact and/or pressing on of the connector; and
sealing to the contact carrier by an outer diameter which is always identical.

### BRIEF DESCRIPTION OF THE DRAWING

Other objects and advantages will become apparent from a study of the following description when viewed in the light of the accompanying drawings in which:

FIG. 1 is a schematic perspective view of a first embodiment of a wiring set according to the invention;

FIG. 2 is a schematic perspective view of a connecting element of the embodiment shown in FIG. 1;

FIG. 3 is a schematic, enlarged perspective view of a portion of the connecting element taken along region III of FIG. 2;

FIG. 4 is an enlarged schematic perspective view of a portion of the wiring set taken along region IV of FIG. 1;

FIG. 5 is an enlarged schematic perspective view of a section of a connecting element of a variation of the embodiment shown in FIG. 1;

FIG. 6 is a sectional view of the inventive plug-in connector shown in FIG. 1;

FIGS. 7 and 8 are top perspective views of the plug-in connector of FIG. 1 without and with a mounting tool, respectively;

FIG. 9 is a sectional view of an insulating body for the plug-in connector shown in FIGS. 6-8; and

FIG. 10 is a sectional view of a variation of an insulating body for the plug-in connector shown in FIG. 9.

### DETAILED DESCRIPTION

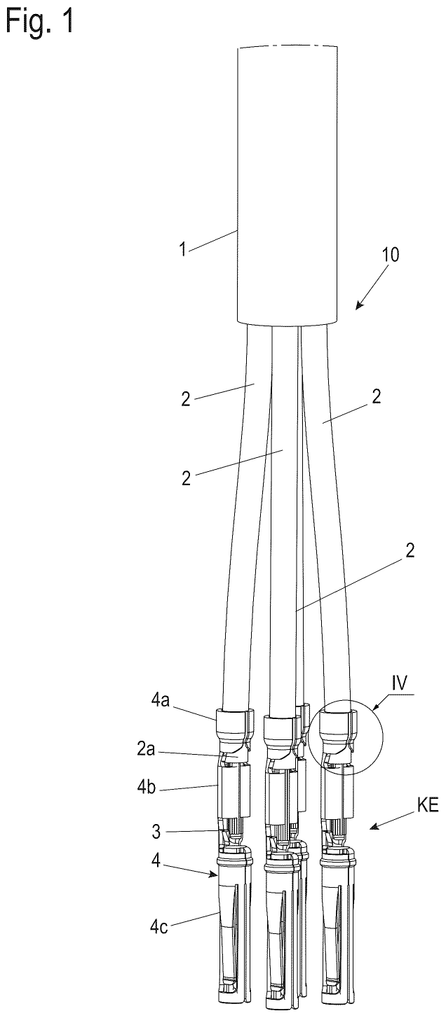

FIG. 1 depicts a perspective view of a first embodiment of a wiring set 10 according to the invention.

The wiring set 10 includes a cable 1 with at least one insulated wire 2 and one contact unit KE.

In the example shown, the cable 1 has four insulated wires 2. Each insulated wire 2 is an electrical conductor 3 with an insulation layer. The electrical conductor 3 can be a single wire or a stranded wire.

The contact unit KE has at least one electrically conductive connecting element 4 for connecting an insulated wire 2 to an electrically conductive pole of a terminal (not shown). Such a terminal can be a socket element or a plug-in element. In the illustrated embodiment, one connecting element 4 is allocated to each insulated wire 2 of the cable 1.

Each connecting element 4 is configured with a plugging socket for contacting a contact in a mating plug and, for the purpose of linking up to one insulated wire 2, respectively, has a first connecting section 4a and a second connecting section 4b.

In this embodiment, the connecting element 4 is configured as a crimping element. Of course, other configurations are also possible, such as a turned part.

In the example of the crimping element shown, the first connecting section 4a is an insulation crimp and the second connecting section 4b is a conductor crimp.

The first connecting section 4a forms a mechanical fastening of a retaining section 2a of the insulated wire 2 in the end region of the insulation of the wire.

A stripped end section of the conductor 3 of the insulated wire 2 is fastened in a mechanical and electrically conductive manner in the second connecting section 4b by a crimping or pressing process.

The second connecting section 4b is connected in an electrically conductive manner in one piece with a contact section 4c which forms the plugging socket. Instead of the plugging socket, the connecting element 4 can also be provided with a plug element, e.g. a plugging pin, as the contact section 4c.

The contact unit KE is designed for installation in a contact carrier 7 as described further below.

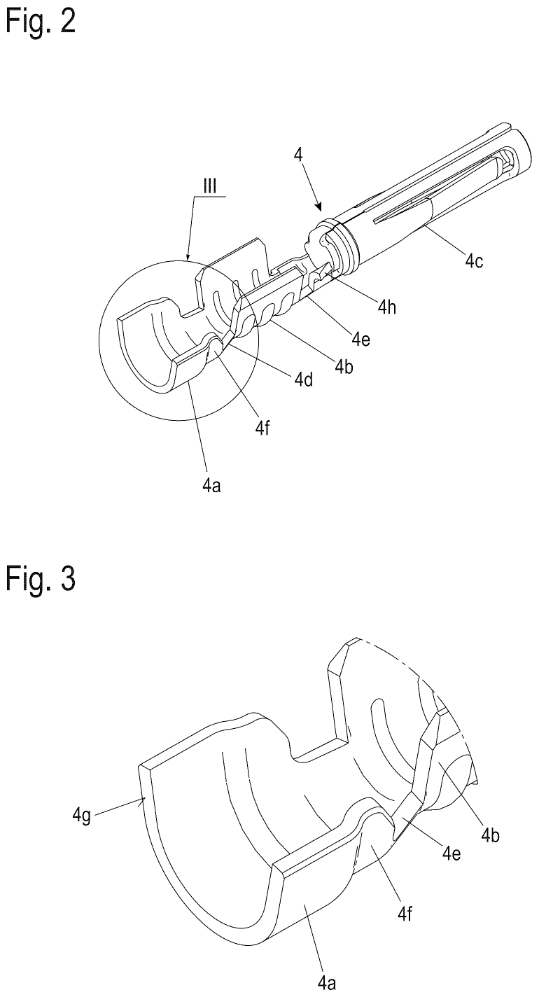

FIG. 2 shows a schematic perspective view of a connecting element 4 of the embodiment shown in FIG. 1.

FIG. 3 shows a schematic, enlarged perspective view of region III of the connecting element 4 according to FIG. 2.

FIG. 2 depicts the connecting element 4 before assembly. The first connecting section 4a and the second connecting section 4b are connected to one another by a first connecting web 4d. The contact section 4c is attached to the second connecting section 4b via a second connecting web 4e.

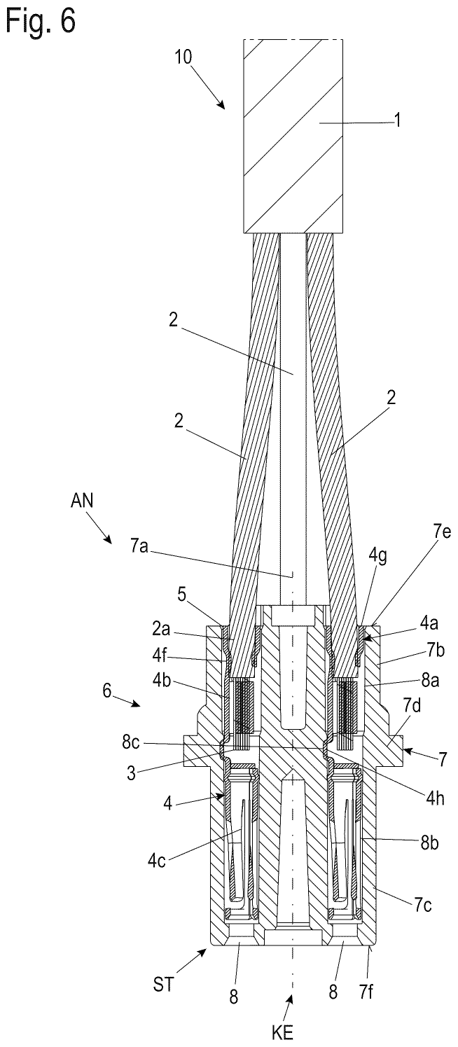

An outwardly projecting protrusion 4h is molded on the second connecting web 4e. This protrusion 4h is used to secure the connecting element 4 when inserting or pushing the connecting element 4 into the contact carrier 7 and is explained further below in connection with FIG. 6.

A free end of the first connecting section 4a has an end face. The first connecting sections 4a are configured at the end face with a uniform, stable, largely circumferentially accessible mounting edge 4g. The mounting edge does not always have to be closed in its circumference, as this depends on the thickness of the conductor. The other end of the first connecting section 4a merges into an offset section 4f which in turn is connected to the second connecting section 4e.

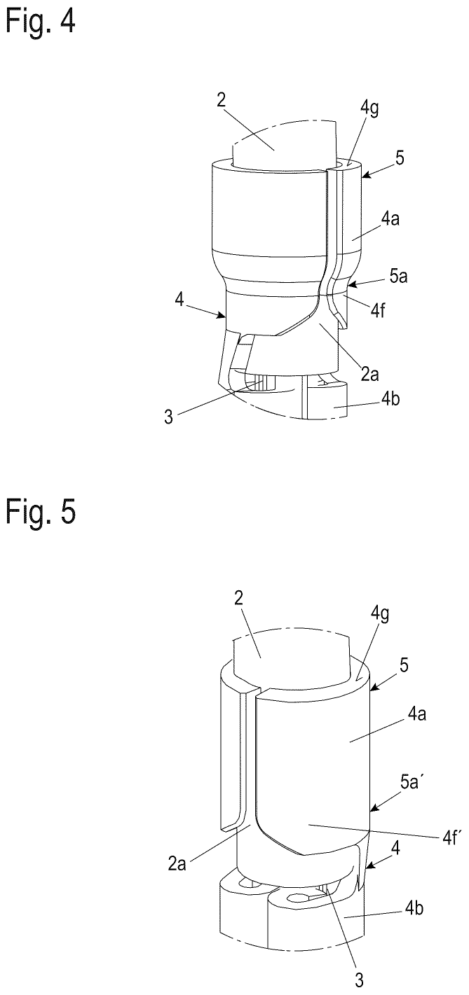

FIG. 4 is an enlarged perspective view of region IV of the embodiment shown in FIG. 1.

In this view, the insulated wire 2 of the cable 1 is attached, i.e. fastened, to the connecting element 4. The insulated wire 2 is mechanically fastened by its retaining section 2a in the end region of its insulation in the first connecting section 4a by crimping or pressing the first connecting section 4a and crimping or pressing the crimping section 4f.

A first end region 5 of the first connecting section 4a below the mounting edge 4g has a fixed outer diameter which is always manufactured with the same outer diameter as explained in more detail below.

In this embodiment, a second end region 5a of the first connecting section 4a in the offset section 4f has an outer diameter that is smaller than the outer diameter in the first end region 5 of the first connecting section 4a. This is due to the dimensions of the insulated wire 2, as different conductor cross-sections and insulation thicknesses are possible.

At one end of the retaining section 2a, the end of the insulation protrudes out of the offset section 4f via the first connecting web 4d to the second connecting section 4c.

The stripped end region of the conductor 3 is also connected to the second connecting section 4c by crimping or pressing.

FIG. 5 is an enlarged perspective view of a section of a connecting element 4 of a variation of the embodiment shown FIG. 1.

In contrast to the connecting element 4 of the embodiment according to FIG. 1 and FIG. 4, the connecting element 4 of the variation for an insulated wire 2 is provided with larger dimensions (conductor cross-section, insulation thickness) than those of the insulated wire 2 of the embodiment according to FIGS. 1 and 4.

Crimping or pressing of the connection element 4 is shown in FIG. 5. The outer diameter of the first end region 5 close to the mounting edge 4g corresponds to the outer diameter of the first end region 5 of the embodiment of FIGS. 1 and 4.

In this version of the embodiment, however, the outer diameter of the second end region 5a′ of the first connecting section 4a in the offset section 4f′ has the same outer diameter as the first end region 5 of the first connecting section 4a. In other words, the first connecting section 4a has the same outer diameter in all regions. Here, the offset region 4f′ is configured without an offset and lies against the retaining region 2a of the insulation of the insulated wire 2.

FIGS. 6-8 are different views of the embodiment of an inventive plug-in connector 6 of FIG. 1.

FIG. 6 is cross-sectional view of the plug-in connector 6 with the insulated wires 2 of the wiring set 10.

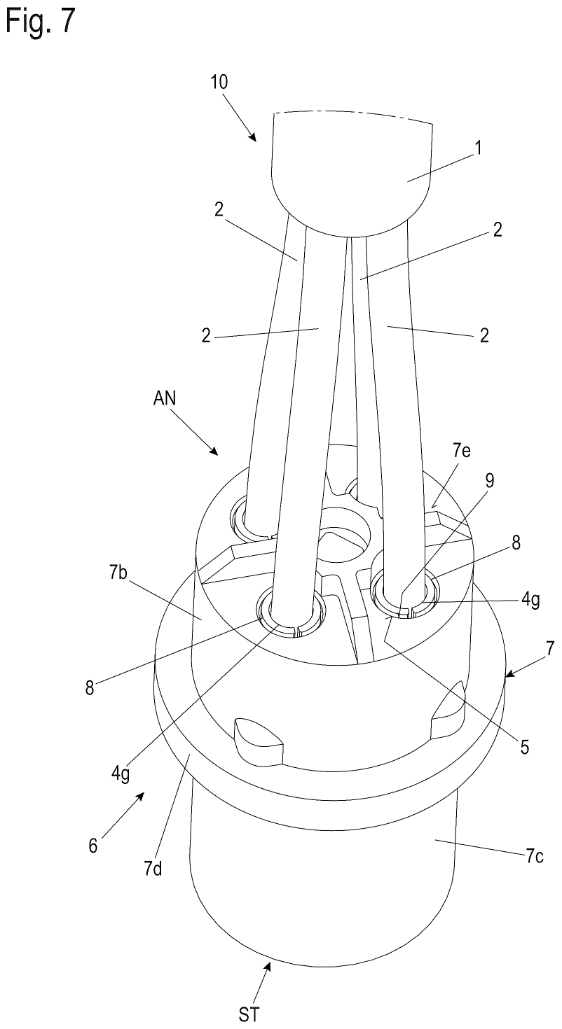

FIG. 7 is a perspective view of the plug-in connector 6 with the wiring set 10 according to FIG. 6.

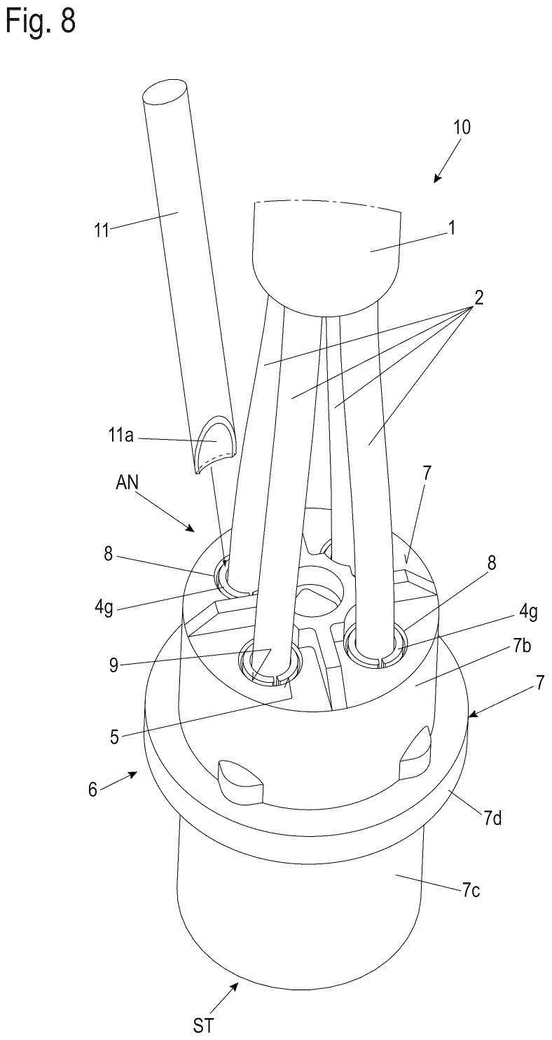

FIG. 8 shows the plug-in connector 6 according to FIG. 7 with a mounting tool 11.

The contact unit KE with the connecting elements 4 of the wiring set 10 is mounted in a contact carrier 7 of a plug-in connector 6 with the aid of a mounting tool 11 as shown in FIG. 8.

Here, the contact carrier 7 is a cylindrical component with a longitudinal axis 7a, with a terminal side AN for the insulated wires 2 and a plug side ST. The contact carrier 7 has a terminal section 7b, a plug-in section 7c, a circumferential collar 7d, an edge section 7e of a first end face of the terminal side AN and a second end face 7f of the plug side ST.

The contact carrier is made of an insulating material, e.g. plastic.

Starting at the terminal side AN, the terminal section 7b extends in the direction of the longitudinal axis 7a and then merges into the plug-in section 7c. The transition from the terminal section 7b and the plug-in section 7c is surrounded by a circumferential, radially outwardly projecting collar 7d.

In this embodiment, the contact carrier 7 has four continuous receptacles 8, which run parallel to the longitudinal axis 7a of the contact carrier from a first end face with the edge section 7e to an opposite second mating end face 7f. The continuous receptacles 8 each serve to accommodate the connecting elements 4.

Each of the continuous receptacles 8 has a terminal receptacle 8a in the region of the terminal section 7a of the contact carrier 7 and a plug receptacle 8b in the region of the plug-in section 7c of the contact carrier 7. The terminal receptacle 8a and the plug receptacle 8b merge into one another in the area of the circumferential collar 7d.

The connecting elements 4 with the insulated wires 2 of the cable 1 attached to them are plugged into the respective continuous receptacles 8 from the terminal side AN. For example, a mounting tool 11 which is shown in FIG. 8 has a beveled mounting end with an opening 11a is used. The tool exerts pressure on the mounting edge 4g of the connecting element 4 during insertion. The opening 11a is shaped corresponding to the insulated wire 2 in order to enclose it and not damage it.

The connecting elements 4 can be mounted manually and/or by machine.

The continuous receptacles 8 are molded into the contact carrier 7 with a circular cross-section and are configured in such a way that the protrusion 4h of a respective connecting element 4 engages in a recess 8c in the area of the transition of a respective terminal receptacle 8a and the associated connector receptacle 8b and thus secures the associated connecting element 4 in a fixed position in the respective continuous receptacle 8.

When the connecting elements 4 are mounted, i.e. plugged in and secured, in the continuous receptacles 8, the first connecting sections 4a and second connecting sections 4b are each arranged in the terminal receptacle 8a with the contact sections 4c each being arranged in the connector receptacle 8b.

The first connecting sections 4a of the connecting elements 4 with the respective insulated wire 2 attached thereto are positioned with their respective end region 5 in the entry area of the respective terminal receptacle 8a. The outer diameter of the end regions 5 corresponds to the inner diameter 9 of the respective terminal receptacle 8a. This is shown in FIGS. 7 and 8. A seal between the first connecting section 4a of the connecting element 4 and the contact carrier 7 is achieved by a narrow clearance or a press fit of the outer diameter of the end regions 5 and the inner diameter 9 corresponding thereto. The spacing of the outside of the first connecting section 4a to the inside of the terminal holder 8a is in a range from a 0.05 mm oversize to a 0.1 mm clearance. For example, the spacing can be approximately 0.05 mm.

The uniform, stable, largely circumferentially accessible mounting edge 4g which is aligned with the edge section 7e of the contact carrier 7 contributes in particular to such a seal.

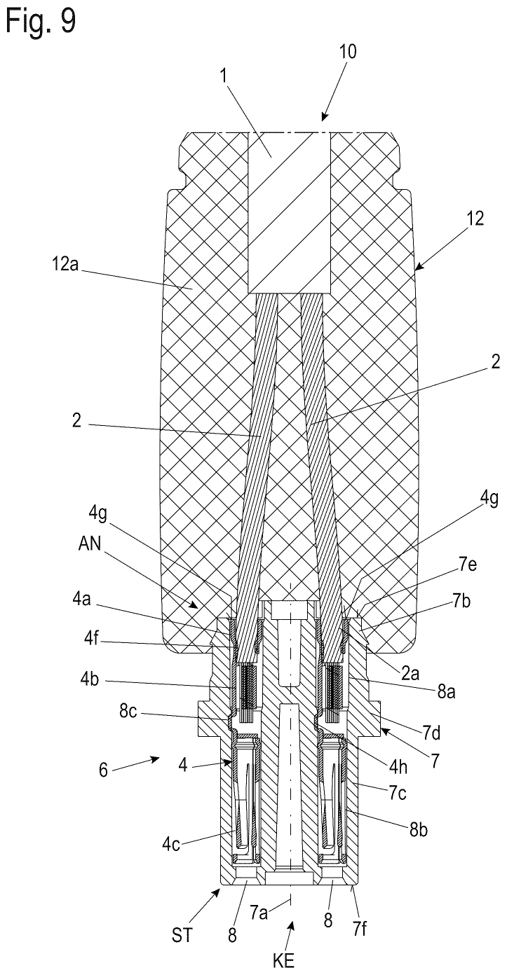

FIG. 9 shows a schematic sectional view of a first embodiment of the inventive plug-in connector 6 according to FIGS. 6-8.

The terminal section 7b is surrounded in its end region on the terminal side AN up to approximately quarter by an end section of an insulating body 12. Furthermore, the insulating body 12 surrounds the free insulated wires 2 of the cable 1 and an end region of the cable 1. In this way, the plug-in connector 6 is firmly connected to the insulating body 12.

The insulating body 12 is formed from an over-molding compound 12a which surrounds the contact carrier 7 of the plug-in connector 6, the insulated wires 2 extending from the terminal side AN of the plug-in connector 6 to the cable 1, and an end region of the insulation of the cable 1.

The over-molding compound 12a is in contact with the outside of the terminal section 7b in the first quarter of the contact carrier 7, with the edge section 7e, the mounting edges 4g of each connecting element 4 and the insulated wires 2 fastened in the first connecting sections 4a and thus forms a seal of the connecting elements 4 outwardly on the terminal side AN of the plug-in connector 6.

Inwardly, i.e. towards the inner region of the continuous receptacles 8 of the contact carrier 7 of the plug-in connector 6, a seal is achieved by the wire insulation of the retaining sections 2a of the insulated wires 2 through the respective offset section 4f of the associated connecting element 4. Depending on the insulation diameter of the retaining section 2a of the insulated wires 2, this occurs by contacting or pressing on the respective offset section 4f.

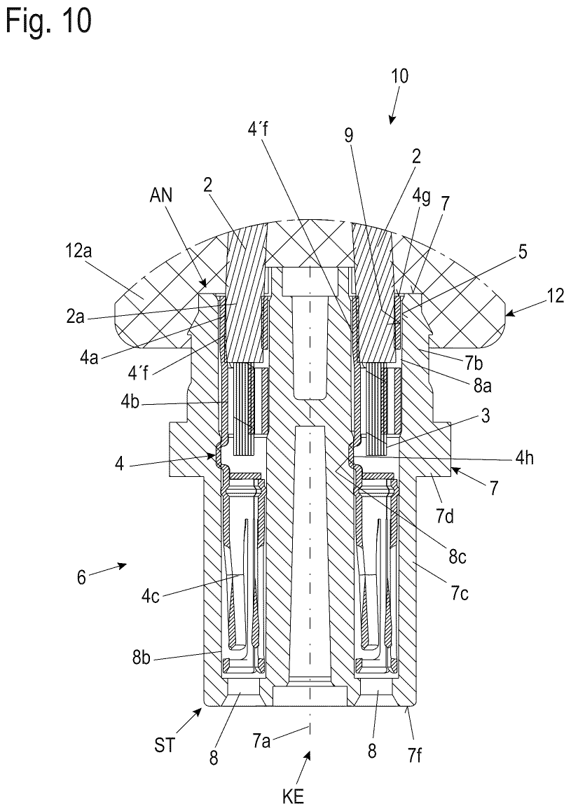

FIG. 10 shows a schematic cross-sectional view of a modification of the embodiment of the inventive plug-in connector 6 according to FIG. 9, wherein an outer diameter of the wire insulation of the retaining sections 2a of the insulated wires 2 is larger than in the embodiment according to FIG. 9. In FIG. 10, the outer diameters of the first connecting sections 4a and the offset sections 4f are the same size and seal the connecting element 4 against the terminal receptacle 8a over the entire length of the first connecting section 4a and offset section 4f.

The connecting elements 4 can be identical parts both for the preferred embodiment and its modifications.

The connecting elements 4 can be configured as stamped-and-bent parts or as turned parts.

The insulating body 12 forms strain relief for the insulated wires 2 and the cable 1 in connection with the plug-in connector 6.

While the preferred forms and embodiments of the invention have been illustrated and described, it will be apparent to those of ordinary skill in the art that various changes and modifications may be made without deviating from the inventive concepts set forth above.

What is claimed is:

1. A wiring set having a plug-in connector, comprising
(a) a cable including at least one insulated wire which is connected with a connecting element in an electrically conductive manner, wherein the connecting element is arranged in a continuous receptacle in a contact carrier of the plug-in connector; and
(b) a first connecting section of the connecting element with which the at least one insulated wire is fastened onto the connecting element has a first outer diameter which corresponds to an inner diameter of a terminal receptacle of the continuous receptacle of the contact carrier.

2. The wiring set as defined in claim 1, wherein the contact carrier of the plug-in connector comprises a cylindrical component having a longitudinal axis, a terminal side of the at least one insulated wire and a plug side, and wherein the contact carrier has a terminal section, a plug-in section, a circumferential collar, an edge section, a first end face of the terminal side, a second end face of the plug side and the at least one continuous receptacle for the connecting element.

3. The wiring set as defined in claim 1, and further comprising a seal of over-molding compound formed between the first connecting section of the connecting element and the contact carrier by a narrow clearance or a press fit of the first outer diameter of the first connecting section of the connecting element and the corresponding inner diameter of the terminal receptacle of the continuous receptacle of the contact carrier.

4. The wiring set as defined in claim 3, wherein a spacing of the outside of the first connecting section to the inside of the terminal holder is in a range from a 0.05 mm oversize to a 0.1 mm clearance.

5. The wiring set as defined in claim 1, wherein a free end of the first connecting section has an end face configured with a uniform, stable, largely circumferentially accessible mounting edge, and wherein an other end of the first connecting section merges into an offset section.

6. The wiring set as defined in claim 5, wherein the offset section of the first connecting section has a second outer diameter which is smaller than the first outer diameter of the first connecting section.

7. The wiring set as defined in claim 5, wherein the offset section of the first connecting section has a second outer diameter which is the same size as the first outer diameter of the first connecting section.

8. The wiring set as defined in claim 7, and further comprising a seal formed on the insulations of the insulated wires by the offset section of the connecting element towards the inner region of the continuous receptacle of the contact carrier of the plug-in connector.

9. The wiring set as defined in claim 8, wherein the terminal section of the contact carrier is surrounded by an end section of an insulating body in its end region on the terminal side, wherein the insulating body surrounds the at least one free insulated wire of the cable and an end region of the cable and firmly connects the plug-in connection to the insulating body.

10. The wiring set as defined in claim 9, wherein the insulating body is formed from an over molding compound.

11. The wiring set as defined in claim 10, wherein the over-molding compound is in contact with an outside of the terminal section in the first quarter of the contact carrier, with the edge section, the mounting edge of the connecting element and the at least one insulated wire fastened in the first connecting section and thus forms a seal of the connecting element outwardly on the terminal side of the plug-in connector.

12. The wiring set as defined in claim 11, wherein the uniform, stable, largely circumferentially accessible mounting edge is aligned with the edge section of the terminal side of the contact carrier.

13. The wiring set as defined in claim 1, wherein the connecting element is a crimping element, wherein the first connecting section is an insulation crimp, a second connecting section is a conductor crimp and a contact section is one of a plugging socket and a plugging pin.
